(19) United States
(12) Patent Application Publication
(10) Pub. No.: US 2013/0142192 A1
(43) Pub. Date: Jun. 6, 2013

(54) VOICE COMMUNICATION APPARATUS FOR INTERMITTENTLY DISCARDING PACKETS

(71) Applicant: OKI ELECTRIC INDUSTRY CO., LTD., Tokyo (JP)

(72) Inventor: Hiromi AOYAGI, Tokyo (JP)

(73) Assignee: OKI ELECTRIC INDUSTRY CO., LTD., Tokyo (JP)

(21) Appl. No.: 13/680,745

(22) Filed: Nov. 19, 2012

(30) Foreign Application Priority Data
Dec. 5, 2011 (JP) 2011-265846

(51) Int. Cl. H04M 7/00

(52) U.S. Cl. CPC H04M 7/006
USPC 370/352

(57) ABSTRACT

In a voice communication device for use on an IP network, a transmitter encodes voice information and assembles RTP packets with the encoded voice information inserted in a payload of the RTP packets to transmit a stream of the assembled RTP packets. RPT packets may intermittently be discarded at a rate of discarding from a stream of the RTP packets to be transmitted. The remaining packets will be transmitted to a destination.

### BACKGROUND OF THE INVENTION

1. Field of the Invention

The present invention relates to a voice communication apparatus, and more particularly to a voice communication apparatus according for example to VoIP (Voice over Internet Protocol).

2. Description of the Background Art

In recent years, IP (Internet Protocol) telephone is prevailing, which is voice communication according to VoIP. IP telephone is a telephonic system in which voice signals are packetized on the Internet protocol to be conveyed to a party connected over an IP network to thereby establish voice communication. In IP telephone, telephone transmitter and receiver terminals and transmission lines are operative asynchronously with each other whereas the clock frequency is required to be exact over a communication path including the telephone transmitter and receiver terminals and intervening devices, such as repeaters and routers. However, the clock frequency may slightly differ between those kinds of devices over the communication paths. In order to absorb such frequency differences, there may typically be provided on the boundaries therebetween buffer facilities for temporarily storing information transmitted.

Particularly with voice signals, a difficulty may be involved such that voice signals may be transmitted over a transmission line without ensuring real-time transmission so as to cause IP packets to arrive at significantly fluctuating time intervals. Thus, for example, on the boundary between transmission lines and telephone receiver terminals there may often be provided a jitter buffer with its storage capacity remarkably larger in order to absorb not only differences in clock frequency but also such fluctuations. Such a solution is disclosed in Japanese patent laid-open publication No. 2007-19767. Whenever packets have arrived consecutively at significantly fluctuating intervals, the jitter buffer is caused to store a significant amount of voice data for an extensive period of time, thus causing speech signal delay to deteriorate the speech quality. In order to reduce such speech signal delay, there is a solution disclosed in U.S. Pat. No. 6,678,660 B1 to Aoyagi et al. Aoyagi et al., proposes a voice communication device using a mechanism which may delete data stored in a jitter buffer.

However, when a communication path is established to include an intervening device such as a repeater or a telephone receiver terminal implemented by a voice communication device comprising a j fitter buffer having no mechanism of reducing speech signal delay by deletion of voice data, the jitter buffer may cause speech signal delay such as to render the speech quality deteriorating.

### SUMMARY OF THE INVENTION

It is an object of the present invention to provide a voice communication apparatus capable of controlling speech signal delay to ensure speech quality even when a communication path on a telecommunications network includes a jitter buffer having no mechanism of reducing speech signal delay by deletion of voice information.

In accordance with the present invention, a voice communication apparatus for use on an IP (Internet Protocol) network comprises a transmitter for encoding voice information and assembling RTP (Real-time Transport Protocol) packets with the encoded voice information inserted in a payload of the RTP packets to transmit a stream of the assembled RTP packets, wherein said transmitter includes: a packet generator for generating the RTP packets to transmit a stream of the generated RTP packets; and a packet discarder for intermittently discarding an RTP packet from the stream of the generated RTP packets to be transmitted, and sending the remaining RTP packets.

In accordance with the present invention, a non-transitory computer-readable recording medium having a program recorded which controls,when installed on and executed by a computer, the computer to function as the voice communication apparatus described above.

In accordance with the present invention, some RTP packets may intermittently be discarded, so that the stored amount of data in a jitter buffer on a receiver side can be decreased to control speech signal delay, thus ensuring the speech quality.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram showing the configuration of a voice communication terminal in accordance with a preferred embodiment of the present invention;

FIG. 2 is a schematic block diagram showing the transmitter in the voice communication terminal of FIG. 1;

FIG. 3 is a schematic block diagram showing the configuration of an alternative embodiment to the transmitter shown in FIG. 1; and

FIG. 4 is a schematic block diagram showing the configuration of another alternative embodiment to the transmitter shown in FIG. 1.

### DESCRIPTION OF THE PREFERRED EMBODIMENTS

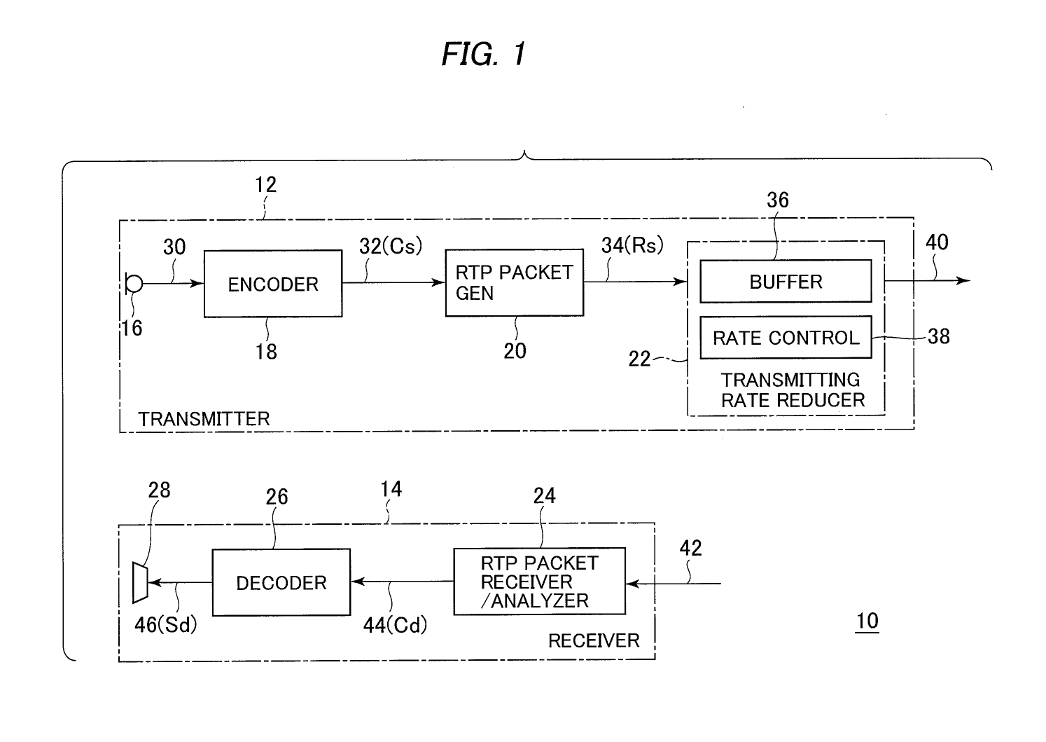

Preferred embodiments of the voice communication apparatus in accordance with the present invention will be described with reference to the appended drawings. Referring to FIG. 1, an embodiment of the voice communication apparatus in accordance with the present invention is directed to a voice communication terminal, such as IP (Internet Protocol) telephone, including IP soft phone. The voice communication device 10 comprises a transmitter 12 for encoding voice information and assembling RTP (Real-time Transport Protocol) packets with the encoded voice information inserted into the payload thereof to transmit a stream of the generated RTP packets, and a receiver 14 for receiving signals transmitted from a communication party connected, or involved in a session established, over a telecommunications network such as an IP network. Specifically, in the transmitter 12, an RTP packet generator 20 generates RTP packets to deliver a stream 34 (Rs) of the generated packets to a transmitting rate reducer 22, which may in turn intermittently or periodically discard some of the RTP packets from the generated RTP packet stream 34 (Rs) to be transmitted, and then transmits the remaining RTP packets 40, whereby the stored amount of data in a jitter buffer on a receiver side will be decreased so that speech signal delay can be controlled to ensure the speech quality.

Further, when the intermittent or periodic discard of data in a jitter buffer on a receiver side is controlled according to the stored amount of data in the jitter buffer, RTP packets can be prevented from overflowing the jitter buffer so as not to be discarded at a burst, resulting in preventing the speech quality from significantly deteriorating. Elements and components not directly relevant to understanding the present invention of the communication apparatus will not be shown and described. Signals and data will be indicated with reference numerals for connecting lines on which they appear.

The voice communication device 10 may be a voice communication terminal, such as IP telephone handset or subscriber set, including IP soft phone. The voice communication device 10 comprises the transmitter 12 and receiver 14, as shown in FIG. 1. As will be described later, some of the components can also be implemented with a processor system including a CPU (Central Processing Unit) and computer program sequences which may be stored in a computer-readable storage medium and executed on the CPU. Even in such a case, the functional configuration can be depicted in a block diagram as shown in FIG. 1. In this connection, the word “circuit” or “device” may be understood not only as hardware, such as an electronics circuit, but also as a function that may be implemented by software installed and executed on a computer.

The transmitter 12 of the illustrative embodiment comprises a microphone 16, an encoder 18, an RTP (Real-time Transport Protocol) packet generator 20 and a transmitting rate reducer 22, which are interconnected as depicted. The receiver 14 includes an RTP packet receiver/analyzer 24, a decoder 26 and a loudspeaker 28, which are interconnected as shown. When the illustrative embodiment is adapted for a wireless communication system, the transmitter 12 and receiver 14 may have the respective antennas thereof or a common antenna, which are omitted from depiction.

In addition, the receiver 14 may be the same type as an existing receiver having no mechanism of reducing the stored amount of data in a jitter buffer.

The microphone 16 has a function for capturing sound which may include a user's speech voice to convert the captured sound into a analog voice signal representative of the sound. The microphone 16 is connected to deliver the resultant analog voice signal 30 to the encoder 18.

The encoder 18 has a function for converting the analog voice signal 30 inputted from the microphone 16 into a corresponding digital voice signal, and encoding the digital voice signal into speech-encoded data 32 (Cs), which will be fed to the RTP packet generator 20. The encoder 18 may be implemented by, for example, ITU-T (International Telecommunications Union-Telecommunications Standardization Sector) Recommendations G.711, applicable as its speech-encoding scheme.

The RTP packet generator 20 has a function for assembling the speech-encoded data 32 (Cs) into RTP packets 34 (Rs) to be transmitted to a voice communication device on a communication party to which a communication path or session is to be established over the IP network. The RTP packet generator 20 transfers the assembled RTP packets 34 (Rs) to the transmitting rate reducer 22. In the illustrative embodiment, the RTP packet generator 20 may be adapted to assemble a digital voice signal for example of 20 ms long into one frame, and insert a frame of the obtained speech-encoded data 32 (Cs) into the payload of an RTP packet. Thus, RTP packets are generated every 20 ms with the illustrative embodiment.

The transmitting rate reducer 22 is a packet discarder adapted for discarding some of the RTP packets from a supplied stream of the RTP packets 34 (Rs) at the rate of discarding, and transmitting the remaining RTP packets to a voice communication device of a mating party to which a communication session is established. The rate of intermittently, or periodically discarding RTP packets may be set to a predetermined value, or adaptively variable. In order to implement this function, the transmitting rate reducer 22 may include a buffer 36 and a rate control 38. The transmitting rate reducer 22 sends the remaining RTP packets 40 toward the communication party over the IP network.

The rate of discarding may be set to a predetermined value such that an average period of time during which packets remain stored in a jitter buffer, and hence delay time, even if a voice communication device involved in a connection session to be established includes a jitter buffer having no mechanism of reducing the stored amount of data would not cause the speech quality to deteriorate. The rate control 38 has the function of controlling the rate of discarding to a predetermined value. The voice communication device 10 thus reduces, or thins out, RTP packets to be transmitted from the transmitter side at the predetermined rate, resulting in reduction of the stored amount of data in a jitter buffer included in the voice communication device of a party to which a communication session is to be established.

The rate control 38 may apply a predetermined value of, for example, 10% as the rate of discarding to perform the discard control. In such a case, the transmitting rate reducer 22 may be implemented by incorporating therein a counter adapted for counting ten packets and discarding one RTP packet every ten RTP packets. Alternatively, although not shown as the rate control 38 in the figure, the transmitting rate reducer 22 may incorporate therein at least a counter adapted for counting RTP packets up to 12 packets, and a random number generator for generating natural numbers at random, the counter being set with its full count selectively provided among five values, such as numbers “8”, “9”, “10”, “11” and “12”, from the the random number generator so that each time the counter reaches the set number one packet is discarded. The latter system may discard one packet for every ten packets in average while the time period between discarded packets is variable in a range between eight and twelve packets.

Now, the receiver 14 will be described. The RTP packet receiver/analyzer 24 includes a jitter buffer, not specifically shown. The receiver/analyzer 24 has a function for determining whether or not an incoming RTP packet 42 has its destination address corresponding to the address of a party to which a communication connection or session is to be established, and thereafter storing the RTP packet or data contained in its payload while taking out the oldest RTP packet from the jitter buffer to extract speech-encoded data 44 (Cd) stored in the payload of the RTP packet thus taken out. The RTP packet receiver/analyzer 24 delivers the extracted speech-encoded data 44 (Cd) to the decoder 26. In an application where the decoder 26 requires a sort of speech-encoded data in order to maintain the continuity of reproducing voice even when the jitter buffer is empty, the RTP packet receiver/analyzer 24 may be adapted for delivering dummy data to the decoder 26.

The decoder 26 has a function for decoding the supplied speech-encoded data 44 (Cd) and converting a resultant digital voice signal into a corresponding analog voice signal 46 (Sd). The decoder 26 drives the loudspeaker 28 with the obtained analog voice signal 46 (Sd). The decoder 26 may be adapted to interpolate, when it receives dummy speech-encoded data from the receiver/analyzer 24 as stated above, data with a voice signal previously decoded to continuously produce a voice signal, rather than decoding the dummy speech-encoded data.

The loudspeaker 28 functions as converting the supplied analog voice signal 46 (Sd) into audible sound. Thus, the loudspeaker 28 reproduces the speech voice transmitted over the telecommunications network from a party to which a communication session is established.

In the transmitter 12, the digital voice signal processing function of the encoder 18 as well as the RTP packet generator 20 and the transmitting rate reducer 22 may be implemented by a computer system on which program sequences as such may be executed. In the receiver 14 also, the functions of the RTP packet receiver/analyzer 24 and the decoder 26 for producing a digital voice signal may be implemented by a computer system on which program sequences as such may be executed.

Now, operations of the voice communication device 10 will be described in the order of the transmitter 12 and receiver 14. Voice uttered by the user is captured with the microphone 16 and the obtained analog voice signal 30 is sent to the encoder 18. The analog voice signal 30 is converted by the encoder 18 into a corresponding digital voice signal, which is in turn speech-coded. The obtained speech-coded data 32 (Cs) are supplied to the RTP packet generator 20. The RTP packet generator 20 assembles the speech-coded data 32 (Cs) into RTP packets 34 (Rs), which will be supplied to the transmitting rate reducer 22.

The transmitting rate reducer 22 discards some packets from a stream of the RTP packets supplied from the RTP packet generator 20 at a predetermined rate, as described earlier. The remaining RTP packets 40 will be transmitted toward a voice communication device of a destination party to which the communication session is established.

The voice communication device 10 receives a digital voice signal 42 on its receiver 14. The digital voice signal is in the form of RTP packets. The RTP packet receiver/analyzer 24 of the receiver 14 determines whether or not it has received an RTP packet addressed to this voice communication device 10 from the party to which the communication session is established. An RTP packet thus determined as addressed to the communication device 10 is stored in the jitter buffer included in the RTP packet receiver/analyzer 24. This storing causes jitters of the RTP packets to be absorbed. Thence, the RTP packet is taken out from the jitter buffer, and the speech-coded data stored in the payload is extracted. The extract speech-coded data 44 (Cd) are supplied to the decoder 26.

The speech-coded data 44 (Cd) are decoded by the decoder 26. The obtained digital voice signal is converted by the decoder 26 into a corresponding analog voice signal 46 (Sd), which is then supplied to the loudspeaker 28. The loudspeaker 28 is driven with the analog voice signal 46 (Sd) to produce speech voice.

Unlike the preferred embodiment, if the voice communication device 10 on a transmitter side were not adapted to discard RTP packets, then the number of RTP packets transmitted per unit time from the voice communication device on the transmitter side would accord with the number of RTP packets received per unit time by a voice communication device on a receiver side. In such a case, the amount of information fed into the jitter buffer of the RTP packet receiver/analyzer 24 would become equal to the amount of information output per unit time from that jitter buffer, so that, when the data have been stored in the jitter buffer, the stored amount of data in the buffer would not substantially change.

With the preferred embodiment, however, the voice communication device 10, when functioning on a transmitter side, is adapted to discard RTP packets at a given rate of discarding at least in average. Accordingly, taking a unit period of time, more information is output from the jitter buffer of the RTP packet receiver/analyzer 24 than input to that jitter buffer, so that the amount of data stored in the jitter buffer usually tends to decrease.

In accordance with the preferred embodiment, even when a communication session includes on its receiver side a voice communication device having a jitter buffer provided with no mechanism of absorbing speech signal delay by deleting voice data, speech signal delay can be controlled to ensure the speech quality.

Also in accordance with the preferred embodiment, RTP packets are intermittently discarded and remaining packets are transmitted so that the receiver side will receive the RTP packets intermittently as well. As a result, the speech quality may deteriorate in comparison with the case of transmitting all of the RTP packets.

In the conventional solutions, however, when the jitter buffer of a voice communication device on a receiver side becomes nearly full, a longer speech signal delay occurs, which causes to damage the speech quality. Further, in a situation where the jitter buffer overflows, a large number of RTP packets may be discarded at a burst in a short time. Such bursting discard of RTP packets causes to significantly damage the speech quality. By contrast, with the preferred embodiment, the voice communication device 10 has the interpolating function for lost packets on a receiver side in case the packet loss occurs intermittently so that the interpolating function may act effectively. Even then, however, when the packet loss occurs at a burst, it would be difficult to recover the speech quality, notwithstanding that the interpolating function acts.

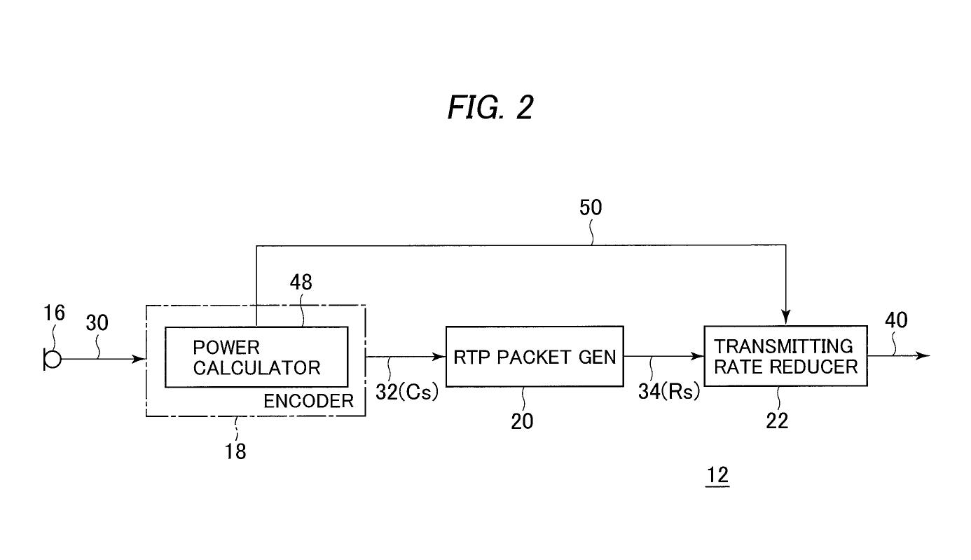

An alternative embodiment of the voice communication device in accordance with the present invention will be described with reference to FIG. 2. In the alternative embodiment, the receiver 14 may be the same as FIG. 1, on which repetitive description will be avoided, and FIG. 2 shows the transmitter 12 only.

In the alternative embodiment, the transmitter 12 may generally be the same in configuration as FIG. 1. Like components are designated with the same reference numerals throughout the entire patent application, of course. The encoder 18 of the alternative embodiment includes a power calculator 48. The power calculator 48 has a function for derive information on power, such as the average and maximum powers of the frames of digital voice signals to be speech-coded. The power calculator 48 supplies information on the calculated power 50 to the transmitting rate reducer 22. The transmitting rate reducer 22 references the supplied power information 50 to determine whether to discard RTP packets.

For example, when the rate of discarding is 10%, the transmitting rate reducer 22 generally discards one packet every ten packets. The transmitting rate reducer 22 may be arranged such that, when the transmitting rate reducer 22 selectively discards either one of the 9th, 10th and 11th RTP packets as counted from the RTP packet previously discarded, it compares the power information 50 of the RTP packets between the 9th through 11th packets to then determine an RTP packet having information 50 representing the lowest power thereamong to be discarded.

The instant alternative embodiment can also provide the advantages similarly to the foregoing preferred embodiment. Furthermore, this alternative embodiment is arranged to discard an RTP packet conveying voice data exhibiting the power information that is less effective on the speech quality, and therefore the degree of deterioration of the speech quality caused by discarding RTP packets can be minimized.

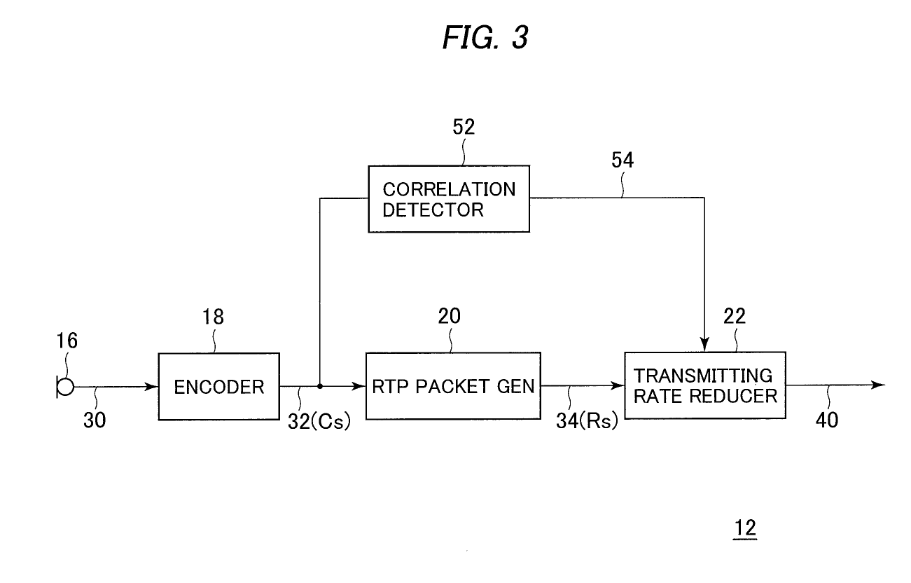

Well, another alternative embodiment of a voice communication device in accordance with the present invention will be described with reference to FIG. 3. The transmitter 12 of the instant alternative embodiment additionally includes a correlation detector 52.

The correlation detector 52 is interconnected to be given the digital voice signal 32 from the decoder 18. The correlation detector 52 has a function for storing digital voice signals at least over a predetermined period of time immediately preceding thereto, and determining a location, i.e. packet, where its correlative value is highest among the digital voice signals thus stored. The predetermined period of time may correspond to, for example, three frames, i.e. 60 ms. The correlation detector 52 supplies the correlative value 54 thus located to the transmitting rate reducer 22. The transmitting rate reducer 22 references the supplied correlative value 54 to determine an RTP packet to be discarded.

For example, when the rate of discarding is 10%, the transmitting rate reducer 22 generally discards one packet every ten packets. The transmitting rate reducer 22 may be adapted such that, when the rate reducer 22 selectively discards either one of the 9th, 10th and 11th RTP packets as counted from the RTP packet previously discarded, it compares the correlative values for the RTP packets between the 9th through 11th packets to then determine an RTP packet having the highest correlative value thereamong to be discarded.

The present alternative embodiment can also provide the advantages similarly to the illustrative embodiment shown in and described with reference to FIGS. 1 and 2. This alternative embodiment is thus arranged to discard an RTP packet that may easily be interpolated on a receiver side, and therefore the degree of deterioration of the speech quality caused by discarding RTP packets can be minimized.

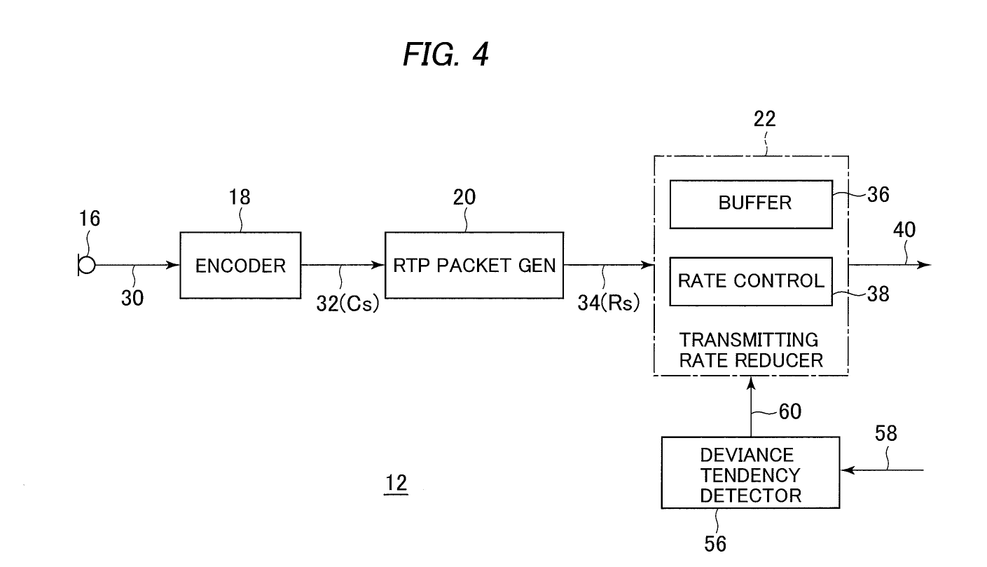

Still another alternative embodiment of a voice communication device in accordance with the invention will be described with reference to FIG. 4. The transmitter 12 of this alternative embodiment additionally includes a deviance tendency detector 56.

The deviance tendency detector 56 is interconnected to receive “deviance” information 58 on the stored amount of data in the jitter buffer, not shown, of the RTP packet receiver/analyzer 24 of the receiver 14 on a real-time basis. The deviance tendency detector 56 has a function for grasping or analyzing the tendency of long-term change in the stored amount of data in the jitter buffer to determine whether the long-term change in deviance caused by differences in clock frequency remains substantially constant, or tends to substantially increase or decrease. The deviance tendency detector 56 provides the rate control 38 of the transmitting rate reducer 22 with the determination result 60. The rate control 38 sets the rate of discarding to a predetermined value when the supplied determination result 60 represents a substantially unchanging tendency, to a lower value than the predetermined value when the determination result represents a substantially increasing tendency, or a higher value than the predetermined value when the determination result represents a substantially decreasing tendency. The transmitting rate reducer 22 will discard some of the RTP packets at the designated rate and send the remaining RTP packets over the network.

The stored amount of data 58 in the jitter buffer may vary due to jitters or fluctuation on a transmission line. In general, the system clocks of two communication devices involved in a communication session are essentially required to be exactly the same in frequency. In practice, the system clocks may slightly be different in frequency from each other and/or may fluctuate, so that the stored amount of data 58 in the jitter buffers may vary not only by the causes described above but also a frequency deference between the system clocks of both devices.

Jitters may cause the stored amount of data 58 to both increase and decrease, i.e. fluctuate, whereas frequency differences between the system clocks may cause the stored amount of data to exhibit either an increasing or decreasing tendency. The change in the stored amount of data is thus resultant from the multiplier effect from jitters over the transmission lines and frequency differences between the system clocks. It can be estimated, however, that the long-term tendency of change in deviance may generally be reflected by change in the stored amount of data caused by frequency differences between the system clocks. In the context, the term “deviance” maybe understood as a tendency of difference in frequency between system clocks.

Whenever the stored amount of data 58 in the jitter buffer of the receiver 14 of the voice communication device 10 has an increasing tendency, the stored amount of data in the jitter buffer of a voice communication device on a destination party to which the communication session is established has a decreasing tendency accordingly. In that case, the stored amount of data decreases in dependent upon a frequency difference in the system clocks between both devices, wherefore the voice communication device can function in a similar fashion to the preferred embodiment shown in FIG. 2 even when the rate of discarding RPT packets is controlled to be lower than the predetermined value. However, when the stored amount of data 58 in the jitter buffer of the voice communication device 10 has a decreasing tendency, the voice communication device will act contrastively to what is described above, and hence the device will function in a similar fashion to the preferred embodiment shown in FIG. 2 if the rate of discarding RTP packets is set at least slightly higher than the predetermined value.

More specifically, when the deviance tendency detector 56 detects the long-term tendency of change in deviance of the stored amount of data being constant, the deviance tendency detector 56 may set the rate of discarding 80 to a predetermined value, e.g. 10%. When the deviance tendency detector 56 detects the long-term tendency of change in deviance of the stored amount of data increasing, it may set the rate of discarding to a value lower than the predetermined rate, e.g. 5%, half as high as the predetermined value, so as to discard RTP packets accordingly. When the deviance tendency detector 56 detects the long-term tendency of change in deviance of the stored amount of data decreasing, it may set the rate of discarding to a value higher than the predetermined value, e.g. 15%, which is 1.5 times as high as the predetermined value, so as to discard RTP packets accordingly.

The instant alternative embodiment achieves the advantages similarly to the preferred embodiment shown in FIGS. 1 and 2. Moreover, since this alternative embodiment is thus adapted to estimate difference in frequency between system clocks to adaptively control the rate of discarding RTP packets, a difference in frequency appearing between system clocks will cause the discarding of RTP packets to effectively function accordingly to the difference.

The above-described preferred embodiments are arranged to discard RTP packets once generated. Alternatively, encoded voice data to be inserted in a payload per se may be discarded to avoid RTP packets per se from being generated.

The alternative embodiment shown in and described with reference to FIG. 4 is adapted for estimating difference in frequency of a system clock from a voice communication device to which a communication session is established to control the rate of discarding RTP packets accordingly. Alternatively, other kinds of parameters may be utilized which represent the ability of a voice communication device to which a communication session is established to thereby control the rate of discarding RTP packets. For example, the continuity of the sequence number of RTP packets coming from a voice communication device to which a communication session is established in such a manner that, when RTP packets lost on a transmission path are sequential, the ability of a voice communication device to which a communication session is established may be determined lower so as to cause RTP packets readily stagnate in the jitter buffer, and hence the rate of discarding may be increased to exceed the value taken so far.

The afore-described preferred embodiments are directed to a voice communication device installed in a voice communication terminal. The present invention may not be limited to such specific embodiments but may be applied to intervening devices such as repeaters or routers which are adapted for relaying or transferring RTP packets while discarding some of the RTP packets at the rate of discarding.

The entire disclosure of Japanese patent application No. 2011-265846 filed on Dec. 5, 2011, including the specification, claims, accompanying drawings and abstract of the disclosure, is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What is claimed is:

1. A voice communication apparatus for use on an IP (Internet Protocol) network, comprising a transmitter encoding voice information and assembling RTP (Real-time Transport Protocol) packets with the encoded voice information inserted in a payload of the RTP packets to transmit a stream of the assembled RTP packets, wherein said transmitter includes:
a packet generator generating the RTP packets to transmit the stream of the generated RTP packets; and
a packet discarder intermittently discarding an RTP packet from the stream of the generated RTP packets to be transmitted, and sending the remaining RTP packets.

2. The apparatus in accordance with claim 1, wherein said packet discarder further includes a rate controller controlling a rate of intermittently discarding an RTP packet.

3. The apparatus in accordance with claim 2, wherein said rate controller sets the rate of intermittently discarding an RTP packet to a predetermined value.

4. The apparatus in accordance with claim 2, wherein said rate controller variably sets the rate of intermittently discarding an RTP packet.

5. The apparatus in accordance with claim 1, wherein said transmitter further includes an encoder encoding the voice information,
said encoder including a power calculator calculating power of a frame of the voice information to be encoded,
said packet discarder comparing the calculated power of the RTP packets to discard an RTP packet having a lowest power.

6. The apparatus in accordance with claim 1, wherein said transmitter further includes a correlation detector storing a voice signal at least over an immediately preceding predetermined period of time and determining a location where a correlative value is highest among the voice signals stored,
said packet discarder discarding an RTP packet having the highest correlative value which said correlation detector determines.

7. The apparatus in accordance with claim 2, further comprising a receiver receiving a signal transmitted from a communication party to which a communication session is established.

8. The apparatus in accordance with claim 7, wherein said transmitter further includes a tendency detector grasping a tendency of long-term change in a stored amount of data in a jitter buffer of said receiver to determine whether the long-term change caused by difference in clock remains substantially constant, or tends to substantially increase or decrease,
said rate controller controlling the rate of discarding an RTP packet to be transmitted such that said rate controller sets the rate of discarding to a predetermined value when the tendency remains substantially constant, said rate controller sets the rate of discarding to a value smaller than the predetermined value when the tendency behaves substantially increasing, and said rate controller sets the rate of discarding to a value larger than the predetermined value when the tendency behaves substantially decreasing.

9. A non-transitory computer-readable recording medium having a program recorded which controls, when installed on and executed by a computer, the computer to function as a voice communication apparatus for use on an IP (Internet Protocol) network, said apparatus comprising a transmitter encoding voice information and assembling RTP (Real-time Transport Protocol) packets with the encoded voice information inserted in a payload of the RTP packets to transmit a stream of the assembled RTP packets, wherein said transmitter includes:
a packet generator generating the RTP packets to transmit the stream of the generated RTP packets; and
a packet discarder intermittently discarding an RTP packet from the stream of the generated RTP packets to be transmitted, and sending the remaining RTP packets.
